(19) United States
(12) Patent Application Publication
(10) Pub. No.: US 2009/0309286 A1
(43) Pub. Date: Dec. 17, 2009

(54) Booklet Stapling-N-Fold Workstation

(76) Inventor: Maurice McCain, Tampa, FL (US)

Correspondence Address: MAURICE MCCAIN, 10042 OASIS PALM DR, TAMPA, FL, 33615, US

(21) Appl. No.: 12/137,434

(22) Filed: Jun. 11, 2008

(51) Int. Cl. B41L 43/12

(52) U.S. Cl. 270/37

(57) ABSTRACT

A manually operated Workstation that allow users to store, staple and fold collated pages into booklets without the use of a power source. It purposes to create a work environment that allow users to manually perform the task of stapling and folding materials into booklets with a speed and accuracy comparable to that of some more expensive power driven stapling and folding equipment. It comprises a storage bin for (500) sheet of collated papers, a flat bed guide that places booklet papers in perfect alignment under dual staple heads, that simultaneously drive (2) evenly spaced staples when activated by the provided stapling lever. It further provide a folding tray that facilitates accurate folding of booklets before placement in the provided holding tray.

### BACKGROUND OF THE INVENTION

1. Field of the Invention

Heretofore small organizations desiring to distribute their materials in booklet format and in modest quantities, had to either purchase their copies from a commercial provider to utilize their staple and fold services, or print such publications “in house” which would require one to manually staple and fold booklets. In many instances it is too costly (especially when using color) to have copies made commercially and small organizations choose to either settle for black and white publications or do their printing in house. When printing is done in house, however, the stapling and folding is extremely slow and accuracy is a problem. Workers must use a single Long Reach. Stapler and place (1) staple at a time in the center of a sheet of paper so that it can be folded into a booklet. There are some stand alone automatic Staple and Fold machines on the market, but they are too pricey for most small organizations that publish 300 to 400 booklets per week. The present invention provides a inexpensive work environment that allows a worker to manually staple and fold approximately (200) booklets per hour with the same degree of accuracy one could expect from an expensive automatic machine. A more detailed description is contained herein.

2. Background of the Art

N/A

### SUMMARY OF THE INVENTION

Generally, this invention comprehends apparatus to eliminate the prior use of expensive copying services or the purchase of expensive automatic staple and folding devices by providing an inexpensive, manually operated device that allows speed and accuracy comparable to that of expensive automatic systems.

### BRIEF DESCRIPTION OF DRAWINGS

FIG. 1 is a top view of the apparatus that shows flat surface with (2) openings designated 5 and 6 for the purpose of housing a storage space for finished booklets, staple supplies, etc. This view also shows (2) elongated recesses designated 7 which houses (2) Long Reach Staplers that can be easily removed to load staples or correct staple jams.

FIG. 2 is a frontal view of the apparatus that shows a lever designated 17 that moves up and down to suppress a yoke designated 12 which spans two Long Reach Staplers designated 12 to drive two staples simultaneously in center of booklets. This view also shows a opening designated 18 to store collated booklet pages.

FIG. 3 is a side view of the apparatus that shows the Lever designated 17, the yoke designated 12, and the lever pivot designated 8 & 10.

### DESCRIPTION OF EMBODIMENTS

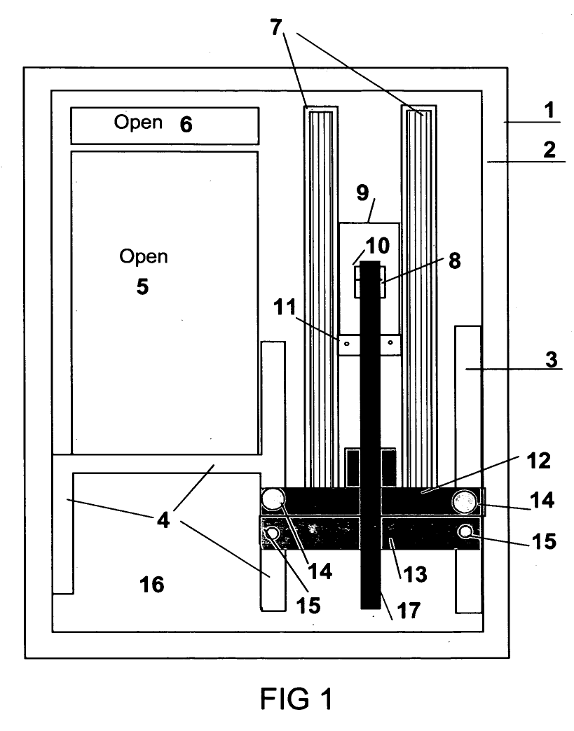

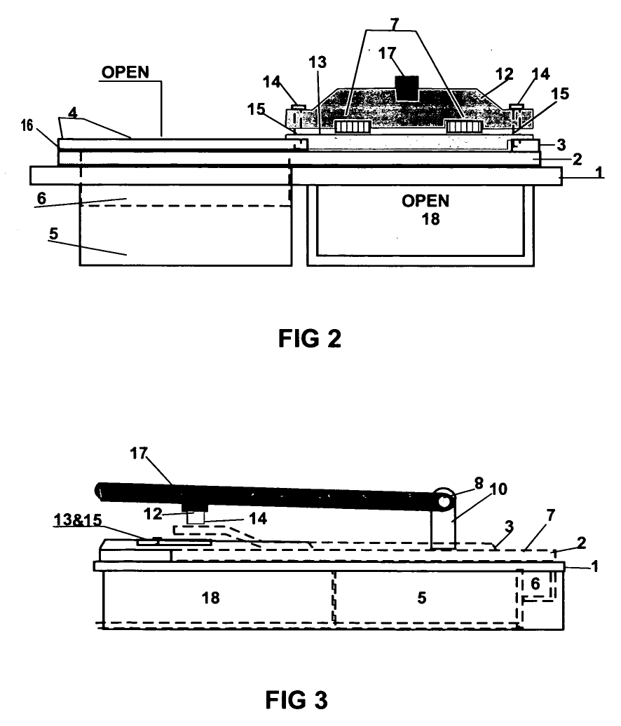

FIG. 1 of the drawings discloses a apparatus with flat platform designated 1 with a flat second imposing platform generally designated 2 with two slots 7 which houses two Long Reach Stapler devices that are activated by a yoke generally designated 12 when operator apply pressure by pulling down on lever generally designated 17 to drive yoke generally 12 in downward motion allowing said yoke to operate the two Long Reach Stapler devices simultaneously. Motion of lever 17 is facilitated by pivoting pin designated 8 on bracket generally designated 10 which rest on a smaller platform generally designated 9. A removable spacer generally designated 11 allows 8.5×11 sheets to be positioned to receive staples precisely in the middle to fold into 5.5×8.5 booklets and when removed allows legal paper size 8.5×14 to be positioned to receive staples in the middle to fold into 7 by 8.5 booklets. A raised bar generally designated 4 forms a folding tray that allow users to accurately fold stapled booklets by pressing edge of papers against backstop of raised bar 4 which causes papers to automatically bend in the center. A opening is provide through both platforms generally designated 5 to hold folded booklets for quick storage and a tray generally designated 6 is provided for storage of staples. An 8.5 wide pathway is created by raised bar generally designated 3 to guide papers for stapling under Long Reach Stapler devices for accurate alignment of staples. An opening generally designated 18 which hold collated printed papers ready for stapling and folding into booklets.

What is claimed is:

1. A booklet staple and folding workstation purposed to substantially increase the speed and accuracy of users who manually staple and fold booklets by creating an organized work environment that provide users the same alignment facilities found in the more expensive power operated devices comprising;
(A) a holding tray to make collated papers for booklets easily accessible for—placement onto a stapling platform;
(B) a stapling platform that align and guide papers to be stapled so that staples are consistently placed in perfect alignment to two long reach stapling devices.
(C) two recessed tracks that hold two generic long reach stapler devices in perfect alignment with aforementioned stapling platform;
(D) a yoke that spans the stapling head of two long reach stapling device so that when pressed down the two long reach stapling devices are actuated simultaneously,
(E) a lever on a pivot that when pressed in a downward motion drives the aforementioned yoke downward causing it to simultaneously actuate the two aforementioned long reach stapling devices;
(F) a folding tray dimensioned to hold stapled papers in perfect alignment so as to allow users with little effort to perfectly fold booklets;
(G) a holding tray for finished booklets to allow convenient storage within the work environment.

2. a fully .green. solution to stapling and folding booklets for small organizations such as churches, desktop publishers, etc. who publish 1,500 booklets or less per week.

3. an economical solution to stapling and folding booklets for small organizations such as Churches, desktop publishers, etc. who publish 1,500 booklets or less per week that allow users equally qualitative and near equal speed of operation available in more expensive power driven devices.
